(19) United States
(12) Patent Application Publication
(10) Pub. No.: US 2025/0058842 A1
(43) Pub. Date: Feb. 20, 2025

(54) SYSTEM AND METHOD FOR A LEGGED ROBOT LIMB CONTROLLER FOR POSITION TRACKING WITH BASE WRENCH LIMITING

(71) Applicant: Ghost Robotics Corporation, Philadelphia, PA (US)

(72) Inventor: Avik De, Philadelphia, PA (US)

(21) Appl. No.: 18/808,831

(22) Filed: Aug. 19, 2024

Related U.S. Application Data
(60) Provisional application No. 63/533,384, filed on Aug. 18, 2023.

(51) Int. Cl. B62D 57/032

(52) U.S. Cl. CPC B62D 57/032

(57) ABSTRACT

The present invention pertains to a system and method for an algorithm to control a robot limb in space while simultaneously controlling the reaction forces applied by it to the robot base. The algorithm automatically creates desired limits on the forces on the basis of the configuration of the robot legs and feet. The algorithm further uses an optimization method followed by an analytical modification of the normal tracking controller, and so is computationally efficient.

### CROSS REFERENCE TO RELATED APPLICATIONS

This application claims the benefit of earlier filed U.S. Patent Application Ser. No. 63/533,384, filed Aug. 18, 2023, the entire contents of which are hereby incorporated by reference.

### BACKGROUND OF THE INVENTION

Legged robots, when paired with limbs that can be utilized for manipulation, can be useful mobile manipulators. To reach objects, it is helpful for an operator to control the position of the end-effector, which can be a gripper or a simple appendage for pulling and/or non-prehensile pushing. In addition, since contact while pushing can be uncertain (slipping might occur), it is helpful to control the impedance of the end-effector via some kind of position-controller. However, after contact is established with an object, and large forces are needed to interact with it, this can affect the stability of the robot base.

Traditionally, robot manipulators capable of powerful motion and high acceleration (for example, in an industrial manufacturing setting) are not expected to make contact with the environment. In such a setting, the motion's impedance profile can be very stiff. However, in the case of a mobile manipulator, contact with the environment is commonplace and to be expected, and it is unsafe to specify a very stiff manipulator impedance because it could result in large forces being applied to the object (or large reaction forces on the mobile base).

Traditional robot manipulators are also typically fixed rigidly at their base, meaning that their reaction forces from the environment due to the inertia of the arm itself are absorbed by the rigid connection to the ground. However, in the case of a mobile manipulator, reaction forces could potentially destabilize the robot base. This could take the form of lifting a legged robot up when pushing down on an object, reducing traction and causing failure, or toppling the legged robot due to large horizontal reaction forces.

### SUMMARY OF THE INVENTION

The present invention pertains to a system and method for an algorithm to control a robot limb in space while simultaneously controlling the reaction forces applied by it to the robot base. In addition, the algorithm automatically creates desired limits on the forces on the basis of the configuration of the robot legs and feet. The algorithm uses an optimization method followed by an analytical modification of the normal tracking controller, and so is computationally extremely efficient. The higher-level task for the robot arm is assumed to be either position or pose tracking, force control, or some combination of the two.

The method involves the following components: position-tracking reference and inverse dynamics, contact detection, applied force limiting, and hybrid position tracking and force limiting.

The position-tracking reference and inverse dynamics is an algorithm that takes desired velocity commands and controls the torque to the robot limb such that the desired velocity is tracked. A consistent set of reference dynamics accounting for the position and velocity error is computed, the output of which is a reference acceleration. This reference acceleration is utilized in an inverse dynamics method that may either work independently or together with the whole body and other limbs. The output of this inverse dynamics step is a set of nominal joint torques. Lastly, these nominal torques may be combined with a feedback term proportional to the velocity error with the reference velocity. We assume that the pose tracking controller computes a desired end-effector wrench (force and torque), and that is converted to joint torques using the limb Jacobian.

The contact detection algorithm assumes that the end-effector under the action of this position-tracking controller can accelerate the end-effector in a manner consistent with a dynamics model for the robot arm. Based on external joint torque measurements and end-effector pose and velocity in the world frame, the algorithm estimates that contact has been made with a high-inertia, immoveable object when the end-effector velocity in the world frame is low and the estimated external force is high. The algorithm has an internal contact state and utilizes hysteresis to ensure that the detection of loss of contact occurs at significantly different thresholds for these measurements, compared to the detection of establishment of contact. The result of the disparate thresholds is that even with noisy sensor measurements of external joint torque or end-effector velocity, the system does not rapidly chatter between contact and non-contact states.

In the contact condition, the applied force limiting algorithm is activated to ensure that reaction forces from pushing on an immoveable object in the environment do not destabilize the robot base. It is assumed that the occurrence of the contact has the effect of constraining relative linear velocity at the contact location, but not necessarily relative angular velocity. In practice, it is unlikely that relative angular velocity is constrained unless the robot end-effector is grasping onto an aspect of the environment. Since this algorithm is meant to handle inadvertent, accidental contact with the environment, it is much more likely that some part of the end-effector bumps into the environment. This corresponds to the existence of contact forces but not contact moments.

The applied force limiting algorithm constrains the force applied by the arm. To formulate the desired constraint on the applied force, it is noted that a legged system has a relationship between the center of pressure, height of the center of mass, and horizontal-plane acceleration. In fact, this relationship can be utilized to enhance pushing with legged systems. Conversely, it can be used to limit the horizontal force on the center of mass (“COM”) by the limits on how much the center of pressure can move. This can depend on the position of the robot feet, size of the feet, and other factors. In the algorithm of the present invention, a set of linear constraints on the horizontal COM force is enforced. Using the whole-body kinematics, a force on the end-effector to a virtual wrench on the COM can be mapped by a linear relationship. This linear relationship allows the development of a set of linear constraints on the applied end-effector force.

A second stability criterion for legged systems is that sufficient vertical reaction force is available at the feet. This can be approximated by a linear constraint on the virtual COM vertical force, which can be mapped as above to a linear constraint on the applied end-effector force. Combining these constraints, the present invention develops a set of linear constraints and creates a feasible polytope for the applied end-effector force. End-effector force inside this polytope may not cause destabilization. In addition, the original position-tracking input from the user or higher-level algorithm may represent a point inside or outside this feasible region. We next use a linear optimization method such as a quadratic program to find the “closest” applied end-effector force to the desired force that satisfies the stability criteria.

The hybrid position tracking, force control, and force limiting allows the present invention to incorporate the projected “safe” applied end-effector force into a higher-level position-tracking or force control task. The difference between these corresponds to the modification that needs to be made to the desired pose tracking command. Based on the applied force difference quantity, the present invention can modify the desired position. To do this, the present invention may add a virtual force to the desired position to ensure it remains near the current position, or modify the desired acceleration proportionally to the applied force quantity, so that the desired and reference dynamics remain consistent. Lastly, we constrain the difference between the desired and current positions so that as the user input moves the desired position while the arm is stuck and in force limiting operational mode, the user input position and the actual position do not diverge too far.

The operator may be informed if the system applies a modification to the user-commanded force or positioning to maintain stability or safety. This notification may occur through an audible signal, a notification or visualization displayed on the controller or its display, or an otherwise perceptible signal on the controller (e.g., vibration).

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 depicts a legged robot.

FIG. 2 depicts a robot arm in seven (7) degrees of freedom (“DoF”) with gripper, 6-DoF without gripper, and 3-DoF non-prehensile pushing configurations.

FIG. 3 shows a flow diagram of the algorithm.

FIG. 4 depicts several applications of the present invention.

### DETAILED DESCRIPTION OF THE PREFERRED EMBODIMENT

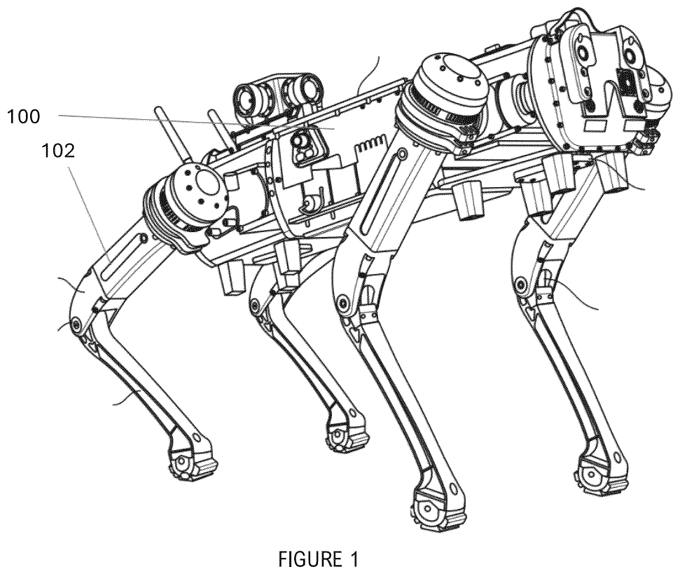

FIG. 1 depicts a legged robot. In accordance with the preferred embodiment of the present invention, a robot comprising a robot base 100 and one or more legs 102 attached to the robot base 100 is controlled via an algorithm, the algorithm automatically creates desired limits on the forces on the basis of the configuration of the robot legs and feet. The algorithm uses an optimization method followed by an analytical modification of the normal tracking controller, and so is computationally extremely efficient. The robot may further comprise at least one robot processing unit capable of receiving commands from at least one processor and at least one user interaction device.

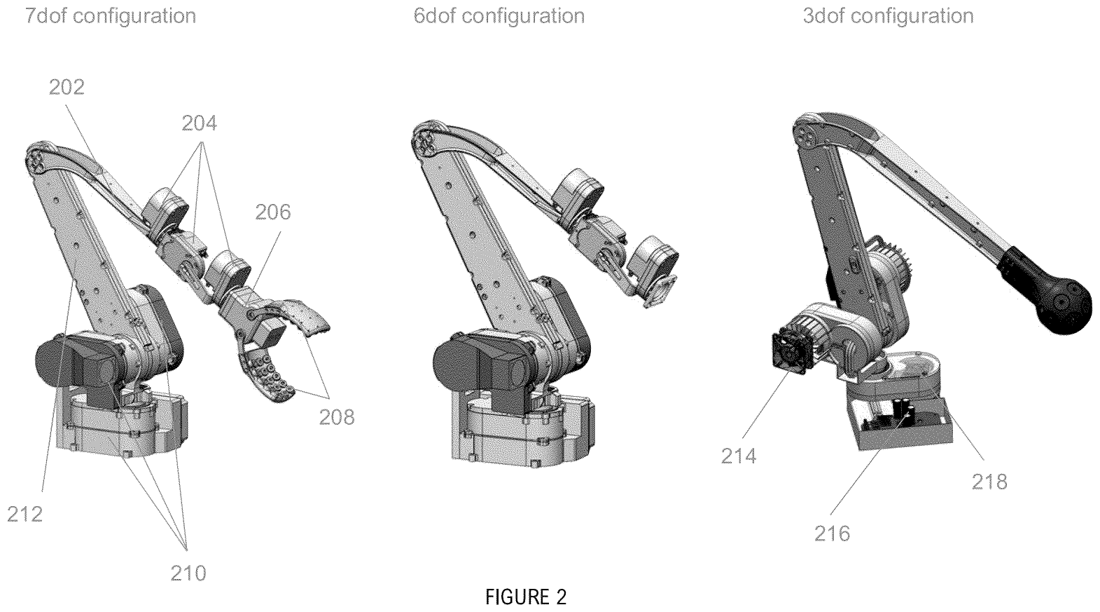

FIG. 2 depicts a robot arm in seven (7) degrees of freedom (“DoF”) with gripper, 6-DoF without gripper, and 3-DoF non-prehensile pushing configurations. In accordance with the preferred embodiment of the present invention, the robot arm may be in a configuration with 7-DoF 200 comprise arm base actuators 210, an arm first link 212, an arm second link 202, wrist actuators 204, a gripper 206, and gripper jaws 208. In an alternative embodiment, the robot arm may have 6-DoF. In this embodiment, the robot arm is not equipped with a gripper 206 or gripper jaws 208 as depicted in the 7-DoF configuration 200. In another alternative embodiment, the robot arm may be in a 3-DoF configuration. In this and other alternative embodiments, the robot arm may be equipped with an arm base actuator encoder 218, arm base actuators drive electronics 216, and arm base actuator cooling fan 214. In this and other embodiments, the 3-Dof configuration is a non-prehensile pushing configuration. In some embodiments of the present invention, the end-effector further comprises a camera or a gripper camera.

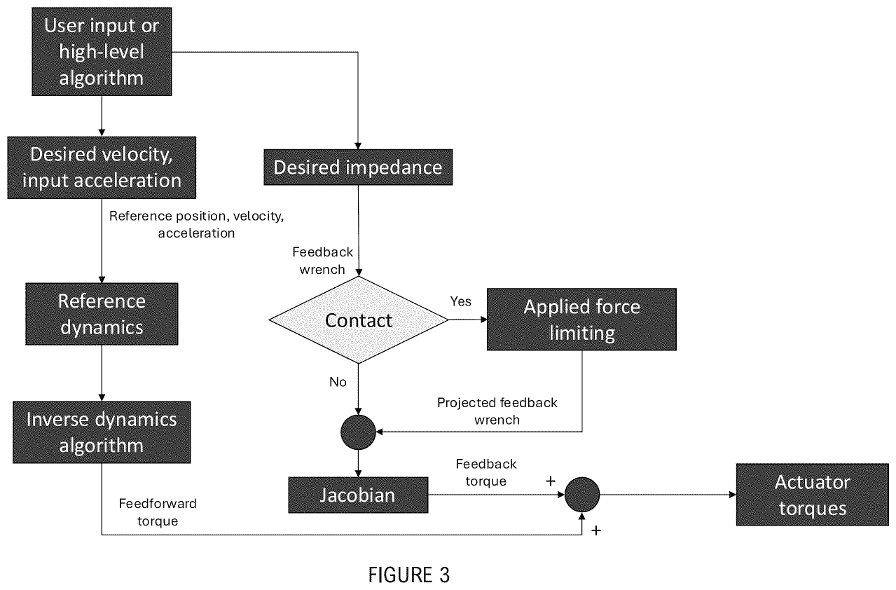

FIG. 3 shows a flow diagram of the algorithm. In accordance with the preferred embodiment of the present invention, first, a user input or higher-level command is received. This command can instruct the robot to move the end-effector at a desired velocity or apply a desired force. For example, in a teleoperation application, a user may use joysticks to command an end-effector velocity proportional to the displacement of the joystick. Alternatively, in a door-opening application, a door-opening algorithm may command a certain force be applied by the end-effector to open a door.

Next, a reference tracking dynamic is computed from the desired velocity command. This controller takes into account the position and velocity errors and computes a consistent reference acceleration. The reference acceleration may be input into an inverse dynamics controller to obtain feedforward torques that would produce the corresponding reference acceleration. A feedback wrench controller in the end-effector task coordinates may next be used to compute a feedback wrench with desired stiffness in the different end-effector coordinates. The estimated external force on the end-effector is computed based on comparing the arm acceleration to a dynamics model of the arm.

A contact estimation algorithm is run, using the estimated external force and current arm twist in the world frame. Based on some preset thresholds, a contact state is either set or cleared. If the contact state is active, the linear (force) component of the feedback is fed into the applied force limiting algorithm to compute the projected allowable applied force, considering the stability of the base. The feedback wrench is modified using the projected applied force. If in position tracking mode, the desired position is modified using the difference between the original and projected applied forces. The modified feedback wrench is converted to joint coordinates using the limb Jacobian to produce the feedback torque. The feedback torque is combined with the feedforward torque and may also be combined with a safety torque. The combined torque is applied to the arm joints.

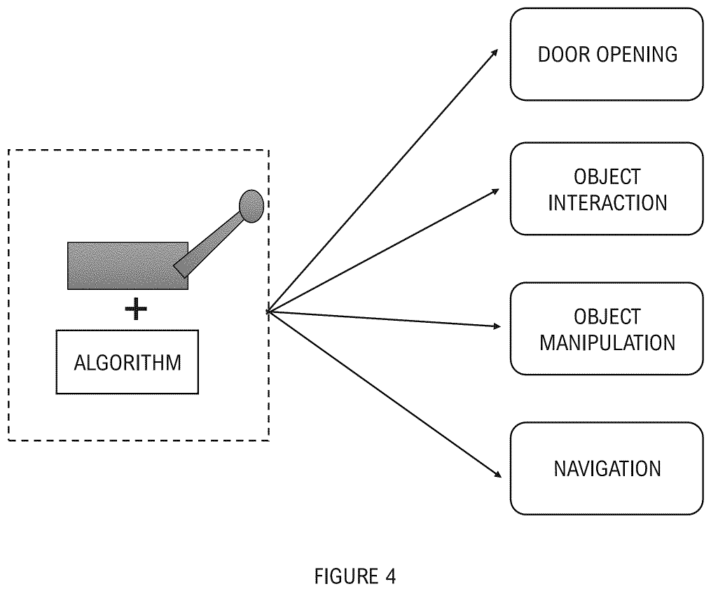

FIG. 4 depicts several applications of the present invention. In accordance with the preferred embodiment of the present invention, the combination of the robot and the algorithm disclosed herein has several real-world applications including but not limited to door opening, object interaction, object manipulation, and navigation. Door opening may further comprise door closing, and may be applied to a plurality of different door and door-like mechanisms (for example, and not by way of limitation, opening and closing a door with a doorknob, a door with a handle, a push/pull door, a sliding door, a door with a push bar, a window, a window with hinges, a window with a crank, a window with locks, etc.). Object interaction may comprise any interaction with an object which may be on the ground or on a raised surface such as a table. Object interaction may comprise, for example and not by way of limitation, pushing, pulling, grabbing, holding, moving, lifting, pressing, touching, deforming or other interaction methods. Object manipulation may comprise, for example and not by way of limitation, picking up an object, turning on an object, turning off an object, putting one object within, on top of, underneath, or next to another object, etc. Navigation may comprise, for example and not by way of limitation, locomoting in a given direction, climbing stairs, climbing a ladder, descending stairs, descending a ladder, jumping, turning, pushing against a surface, lifting onto a surface, ducking beneath an obstacle, stepping over an obstacle, stomping, hopping, etc.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for a legged robot limb controller for position tracking with base wrench limiting, said system comprising:
a robot comprising a robot base and one or more legs attached to said robot base, wherein said robot is controlled via an algorithm,
wherein said algorithm automatically creates desired limits on a plurality of forces based on a configuration of said one or more legs.

2. The system of claim 1, wherein said algorithm performs a method comprising:
computing a consistent reference acceleration;
inputting said consistent reference acceleration into an inverse dynamics controller;
obtaining, from said inverse dynamics controller, a plurality of feedforward torques configured to produce said consistent reference acceleration based on a dynamics model;
computing, via a feedback wrench controller in an end-effector task coordinate, a feedback wrench with a desired stiffness in a secondary end-effector coordinate;
comparing an arm acceleration to a dynamics model of said arm;
computing an estimated external force based on said comparison;
running a contact estimation algorithm using said estimated external force and a current arm twist in a frame;
setting a contact state based on a preset threshold;
feeding a linear force component of said feedback wrench into an applied force limiting algorithm;
computing a projected allowable applied force based on a stability of said robot base;
modifying said feedback wrench based on a comparison of said projected allowable applied force and said linear force component of said feedback wrench;
producing a feedback torque via converting said modified feedback wrench to joint coordinates using a limb Jacobian; and
applying said torque to at least one arm joint.

3. The system of claim 1, wherein said algorithm automatically creates desired limits on a plurality of forces based on a configuration of said one or more legs to cause said robot to interact with a target object.

4. The system of claim 1, wherein said algorithm automatically creates desired limits on a plurality of forces based on a configuration of said one or more legs to cause said robot to navigate a specified area.

5. The system of claim 1, wherein said algorithm uses an optimization method followed by an analytical modification of a normal tracking controller.

6. The system of claim 1, wherein said robot further comprises at least one robotic arm comprising:
an arm base;
a plurality of arm base actuators;
an arm first link;
an arm second link; and
an end-effector.

7. The system of claim 6, wherein said end-effector is a gripper comprising gripper jaws and at least one gripper camera.

8. A method for a legged robot limb controller for position tracking with base wrench limiting, said method comprising:
receiving, via a robot processing unit associated with a robot, an instructional command to move an end-effector at a desired velocity, wherein said robot comprises a base, one or more legs, and at least one arm, and wherein said at least one arm comprises an arm base, a plurality of arm base actuators, an arm first link, an arm second link, and said end-effector;
computing, via an algorithm, reference tracking dynamics from said desired velocity;
computing, via said algorithm, a consistent reference acceleration;
inputting said consistent reference acceleration into an inverse dynamics controller;
obtaining, from said inverse dynamics controller, a plurality of feedforward torques configured to produce said consistent reference acceleration;
computing, via a feedback wrench controller in an end-effector task coordinate, a feedback wrench with a desired stiffness in a secondary end-effector coordinate;
comparing an arm acceleration to a dynamics model of said arm;
computing an estimated external force based on said comparison;
running a contact estimation algorithm using said estimated external force and a current arm twist in a frame;
setting a contact state based on a preset threshold;
feeding a linear force component of said feedback wrench into an applied force limiting algorithm;
computing a projected allowable applied force based on a stability of said robot base;
modifying said feedback wrench based on a comparison of said projected allowable applied force and said linear force component of said feedback wrench;
producing a feedback torque via converting said modified feedback wrench to joint coordinates using a limb Jacobian; and
applying said torque to at least one arm joint.

9. The method of claim 8, wherein said algorithm automatically creates desired limits on a plurality of forces based on a configuration of said one or more legs to cause said robot to open a door.

10. The method of claim 8, wherein said algorithm automatically creates desired limits on a plurality of forces based on a configuration of said one or more legs to cause said robot to navigate a specified area.

11. The method of claim 8, wherein said algorithm automatically creates desired limits on a plurality of forces based on a configuration of said one or more legs to cause said robot to navigate a specified area.

12. The method of claim 8, wherein said end-effector is a gripper comprising gripper jaws and at least one gripper camera.

13. The method of claim 8, wherein said algorithm uses an optimization method followed by an analytical modification of a normal tracking controller.

14. The method of claim 8, wherein said robotic arm has seven degrees of freedom.

15. A system for a legged robot limb controller for position tracking with base wrench limiting, said system comprising:
a robot comprising a robot base, one or more legs attached to said robot base, and at least one robotic arm comprising an arm base, a plurality of arm base actuators, an arm first link, an arm second link, and an end-effector;
wherein said robot is controlled via an algorithm, and wherein said algorithm receives and executes instructions, causing said system to:
compute reference tracking dynamics from a desired velocity;
compute a consistent reference acceleration;
input said consistent reference acceleration into an inverse dynamics controller;
obtain, from said inverse dynamics controller, a plurality of feedforward torques configured to produce said consistent reference acceleration;
compute, via a feedback wrench controller in an end-effector task coordinate, a feedback wrench with a desired stiffness in a secondary end-effector coordinate;
compare an arm acceleration to a dynamics model of said arm;
compute an estimated external force based on said comparison;
run a contact estimation algorithm using said estimated external force and a current arm twist in a frame;
set a contact state based on a preset threshold;
feed a linear force component of said feedback wrench into an applied force limiting algorithm;
compute a projected allowable applied force based on a stability of said robot base;
modify said feedback wrench based on a comparison of said projected applied force and said linear force component of said feedback wrench;
produce a feedback torque via converting said modified feedback wrench to joint coordinates using a limb Jacobian; and
apply said torque to at least one arm joint.

16. The system of claim 15, wherein said end-effector is a gripper comprising gripper jaws and at least one gripper camera.

17. The system of claim 15, wherein said algorithm automatically creates desired limits on a plurality of forces based on a configuration of said one or more legs to cause said robot to open a door.

18. The system of claim 15, wherein said algorithm automatically creates desired limits on a plurality of forces based on a configuration of said one or more legs to cause said robot to navigate a specified area.

19. The system of claim 15, wherein said algorithm automatically creates desired limits on a plurality of forces based on a configuration of said one or more legs to cause said robot to navigate a specified area.

20. The system of claim 15, wherein said robotic arm has seven degrees of freedom.
